(19) United States
(12) Patent Application Publication
(10) Pub. No.: US 2006/0014855 A1
(43) Pub. Date: Jan. 19, 2006

(54) Pigment dispersion with polymeric dispersant

(75) Inventors: Gary L. House, Victor, NY (US); Xiaoru Wang, Webster, NY (US); Anne T. Wyand, Victor, NY (US); Wanda K. Swartz, Albion, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/891,334

(22) Filed: Jul. 14, 2004

(51) Int. Cl. C08K 5/00; C03C 17/00

(52) U.S. Cl. 523/160; 106/499; 106/493; 523/161

(57) ABSTRACT

The invention relates to a pigment dispersion for an ink jet ink composition, the pigment dispersion comprising pigment particles having a median particle size of 200 nm or less, and a polymeric dispersant comprising a random addition copolymer comprising at least one hydrophobic monomer type and at least one hydrophilic monomer type, wherein the polymeric dispersant comprises from 50 weight percent to 80 weight percent of hydrophobic monomers relative to the total weight of the polymeric dispersant, and wherein, when the polymer comprises more than one hydrophobic monomer type, at least 50 weight percent of the hydrophobic monomers relative to the total weight of the hydrophobic monomers is an acrylate comprising an aromatic group. The invention also provides an ink composition and ink jet printing method using the pigment dispersion.

### FIELD OF THE INVENTION

This invention relates to a pigment dispersion with polymeric dispersant and pigment nanoparticles. The pigment dispersion is particularly useful in aqueous pigment-based ink compositions for ink jet printing.

### BACKGROUND OF THE INVENTION

Ink jet printing is a non-impact method for producing printed images by the deposition of ink droplets in a pixel-by-pixel manner to an image-recording element in response to digital data signals. There are various methods that may be utilized to control the deposition of ink droplets on the image-recording element to yield the desired printed image. In one process, known as drop-on-demand ink jet, individual ink droplets are projected as needed onto the image-recording element to form the desired printed image. Common methods of controlling the projection of ink droplets in drop-on-demand printing include piezoelectric transducers and thermal bubble formation. In another process, known as continuous ink jet, a continuous stream of droplets is charged and deflected in an image-wise manner onto the surface of the image-recording element, while un-imaged droplets are caught and returned to an ink sump. Ink jet printers have found broad applications across markets ranging from desktop document and photographic-quality imaging, to short run printing and industrial labeling.

Ink compositions used in ink jet printers can be classified as either pigment-based in which the colorant exists as pigment particles suspended in the ink composition, or as dye-based in which the colorant exists as a fully-solvated dye species that consists of one of more dye molecules. Pigment-based inks are often preferred over dye-based inks because they render printed images that have better resistance to light and ozone as compared to printed images made with dye-based inks.

Today, virtually all pigment-based ink compositions used in photographic-quality ink jet printing have pigment particles in the nanometer-size range. It is well known in the art that when light strikes the surface of a printed image, light scattering occurs if particles at the surface of the printed image are greater than about 300 nm or about the shortest wavelength of visible light. Such light scattering is detrimental because optical density is reduced. As such, pigment-based ink compositions used in today's ink jet printers have pigment particles with average diameters less than about 200 nm. Pigment-based ink compositions having pigment particles with an average diameter of less than about 100 nm are known and are particularly desirable because they not only give high optical densities, but are easy to jet through printheads having small nozzle diameters, for example, less than 25 um.

The process of preparing pigment-based ink compositions usually involves two sequential steps: (a) a milling step to break up crude pigment cake to primary pigment particles, and (b) a formulation step in which the primary pigment particles are diluted with ink components such as water and water-miscible organic compounds to give the final ink composition. In the milling step, the crude pigment cake is typically suspended in a medium that is similar to the final ink composition, and dispersant and milling media are added. Mechanical energy is supplied to this pigment dispersion, and the collisions between the pigment and milling media cause the pigment to deaggregate into its primary particles.

It is well known in the art that the choice of dispersant in the milling step is critical because it facilitates deaggregation and ultimately determines how small the primary pigment particles will be. The dispersant is also critical in maintaining particle stability of the pigment particles both before and after they are formulated to give the final ink composition. The term “particle stability”, as used herein, is often referred in the art as “ink stability”; and refers to the propensity of the primary pigment particles to re-aggregate or flocculate. Flocculation is always a concern because the dispersed state of primary pigment particles is a thermodynamically unstable state, and free energy is minimized as the surface area of the pigment is minimized.

U.S. Pat. No. 6,245,832 describes an ink for ink jet recording containing a pigment and a dispersant having 40 to 80 mole percent of a hydrophilic monomer and 20 to 60 mole percent of a hydrophobic monomer. U.S. Pat. No. 4,597,794 describes an ink jet recording process that utilizes aqueous pigment-based ink compositions. Pigment particles are dispersed with polymers having both hydrophilic and hydrophobic construction portions. U.S. Pat. No. 5,679,138; U.S. Pat. No. 5,651,813 and U.S. Pat. No. 5,985,017 describe the preparation of aqueous pigment-based ink compositions for ink jet printing wherein pigment particles are dispersed with surfactants.

None of the aforementioned references describe or suggest the pigment dispersions of the invention, and there remains a need in the art for pigment dispersions having sufficient particle stability for a broad set of ink jet applications.

### SUMMARY OF THE INVENTION

The invention provides a pigment dispersion for an ink jet ink composition, the pigment dispersion having pigment particles having a median particle size of 200 nm or less, and a polymeric dispersant that is a random addition copolymer comprising at least one hydrophobic monomer type and at least one hydrophilic monomer type, wherein the polymeric dispersant comprises from 50 weight percent to 80 weight percent of hydrophobic monomers relative to the total weight of the polymeric dispersant, and wherein, when the polymer comprises more than one hydrophobic monomer type, at least 50 weight percent of the hydrophobic monomers relative to the total weight of the hydrophobic monomers is an acrylate comprising an aromatic group. In one embodiment the pigment particles are C.I. Pigment Yellow 74.

The invention additionally provides an ink jet ink composition comprising said pigment dispersion, water and a water-miscible organic compound. Also provided is an ink jet printing method comprising the steps of: A) providing an ink jet printer that is responsive to digital data signals; B) loading the printer with an ink jet recording element; C) loading the printer with an ink jet ink composition comprising a pigment dispersion as described above, water and a water-miscible organic compound; and D) printing on the ink jet recording element using the ink jet ink composition in response to the digital data signals.

The invention provides numerous advantages. The invention provides a pigment dispersion wherein the pigment particles have a median diameter of less than 200 nm, such that ink compositions made therefrom render photographic-quality printed images having high optical densities. Furthermore, the invention provides a pigment dispersion wherein the pigment particles exhibit excellent particle stability, i.e., do not re-aggregate or flocculate, when formulated in typical aqueous ink compositions suitable for use in today's ink jet printers, even when such ink compositions are subjected to extreme temperatures over extended periods of time. Pigment dispersions of the invention are also robust in the sense that they can be used in a wide variety of aqueous ink compositions, thereby allowing the ink formulator latitude when designing ink compositions for use with a particular ink jet printer and/or recording element.

The invention also provides ink compositions that are easy to jet through printheads having small nozzle diameters and that do not plug printhead nozzles even after hundreds of pages are printed. As a result, printed images are free of undesirable image artifacts, such as white spots and banding, known to occur when printhead nozzles shut down either temporarily or permanently. Ink compositions of the invention enable extension of printhead lifetime and good storage stability.

Ink compositions of the invention are capable of rendering photographic-quality printed images when printed on a variety of ink jet recording elements, even those having high gloss, and such printed images exhibit long term stability to environmental conditions such as light and ozone. Ink compositions of the invention also provide superior rub resistance even without the addition of polymeric binders to the ink compositions.

### DETAILED DESCRIPTION OF THE INVENTION

The pigment dispersion of the invention consists of pigment particles having a median particle size of 200 nm or less, and a random addition copolymer dispersant that is a random addition copolymer having at least one hydrophobic monomer type and at least one hydrophilic monomer type. The polymeric dispersant contains from 50 weight percent to 80 weight percent of the hydrophobic monomer relative to the total weight of the polymeric dispersant. When the polymeric dispersant containes more than one hydrophobic monomer type, at least 50 weight percent of the hydrophobic monomers relative to the total weight of the hydrophobic monomers is an acrylate having an aromatic group. The invention also provides an aqueous ink jet ink composition and printing method using the pigment dispersion.

The dispersants used in the invention are random copolymers in the sense that they are prepared by randomly copolymerizing ethylenically unsaturated monomers via conventional free radical polymerization methods. These random copolymers are distinct from structured copolymers such as block copolymers, and they are easier to prepare than structured copolymers.

The dispersants used in the invention must be hydrophilic enough such that the pigment particles are rendered soluble in the pigment dispersion and the ink composition. However, the dispersants must also be hydrophobic enough such that adequate adsorption onto the pigment particles is obtained and is maintained under extreme temperatures for extended periods of time. These requirements dictate the hydrophilic/hydrophobic balance that a dispersant must exhibit, and the balance differs depending on the particular pigment as well as the components in the ink composition. Therefore, the particular combinations of monomer types and their respective amounts must be chosen accordingly.

The hydrophobic monomer types are ethylenically unsaturated monomers, of which many are well known in the art and are described in, for example, U.S. Pat. No. 6,652,634 B1; U.S. Pat. No. 6,117,921; U.S. Pat. No. 6,245,832 B1; or U.S. Pat. No. 4,597,794. In general, the hydrophobic monomer types may be alkyl, aryl or alkylaryl derivatives of styrene, vinyl napthalene, acrylic acid, or acrylamide. These hydrophobic monomer types may have other functional groups such as alcohols, ethers, glycols, amines, heterocycles, siloxanes, etc., in order to obtain the desired hydrophilic/hydrophobic balance. Any of these hydrophobic monomer types may be used either individually or in combinations of two or more thereof. The molecular weights of the hydrophobic monomer types are not particularly limited.

In order to obtain the aforementioned advantages of the invention, the hydrophobic monomer is present from 50 weight percent to 80 weight percent relative to the total weight of the polymeric dispersant. There may be one or more type of hydrophobic monomer utilized. If the amount of hydrophobic monomer is less than 50 weight percent, then the polymer cannot mill the pigments to small dispersion particle size or the resulting dispersions and their inks lack sufficient wet durability. If the amount of hydrophobic monomer is greater than 80 weight percent, then the polymeric dispersant does not stay in solution or the resulting dispersion made therefrom solidifies over time.

In order to obtain the aforementioned advantages of the invention, the inventors have found that at least 50 weight percent of the hydrophobic monomers relative to the total hydrophobic monomers must be an acrylate having an aromatic group. Preferably 100 weight % of the hydrophobic monomer is an acrylate having an aromatic group. Presumably, when acrylates having an aromatic group are present in this amount, then the hydrophilic/hydrophobic balance of the polymeric dispersant is optimized for solubility and adsorption such that excellent particle stability is obtained. Examples of useful acrylates having an aromatic ring are described above. In a preferred embodiment, the acrylate is a methacrylate because polymeric dispersants derived therefrom often give better particle stability as compared to the acrylates. For the same reason, the aromatic group is preferably a phenyl group. In another preferred embodiment, the acrylate having an aromatic group has a molecular weight of less than 200. In an especially preferred embodiment, the acrylate having an aromatic group is benzyl methacrylate because polymeric dispersants derived from this monomer tend to work well with a variety of different pigments as opposed to only a few.

The inventors have found that if the acrylate having an aromatic group is present in an amount from 50 weight percent to less than 100 weight percent relative to the total weight of hydrophobic monomers, then preferably the remaining weight percent of hydrophobic monomers are types that are acrylates not having an aromatic group. Examples of acrylates not having an aromatic group include any of those described above, and include, for example, alkyl and alkyl-functionalized acrylates and methacrylates. In another preferred embodiment, the acrylate not having an aromatic group has a molecular weight of less than 200.

The hydrophilic monomer types are ethylenically unsaturated monomers, of which many are well known in the art and are described in, for example, U.S. Pat. No. 6,652,634 B1; U.S. Pat. No. 6,117,921; U.S. Pat. No. 6,245,832 B1; or U.S. Pat. No. 4,597,794. The hydrophilic monomer type may be hydrophilic due to a variety of functional groups including carboxylic acids, sulfonic acids, alcohols, amines, etc., or combinations thereof. In a preferred embodiment, the hydrophilic monomer type contains a carboxylic acid group because it tends to provide the right hydrophilic/hydrophobic balance for a variety of monomer type combinations. Useful hydrophilic monomer types include acrylic acid, methacrylic acid, ethacrylic acid, itaconic acid, etc., or any alkyl, aryl, alkylaryl derivatives thereof; acrylamide, methacrylamide, etc., or any alkyl, aryl, alkylaryl secondary or tertiary derivatives thereof; unsaturated diols; triols; tetraols; etc.; or ethylenically unsaturated heterocyclics. Preferably the hydrophilic monomer type is acrylic acid or methacrylic acid. Any of these hydrophilic monomer types may be used either individually or in combinations of two or more thereof. The molecular weight of the hydrophilic monomer type is not particularly limited.

In a preferred embodiment of the invention, the random addition copolymer dispersant contains benzyl methacrylate and methacrylic acid. These dispersants provide superb particle stability.

The random addition copolymer dispersant may have any molecular weight, as long as the ink composition made therefrom provides reliable and stable jetting over extended periods of time. The number average molecular weight is preferably less than 50,000 for piezo drop-on-demand printheads, and preferably less than 15,000 for thermal drop-on-demand printheads which inherently require high temperatures for jetting. The inventors have found that a preferable number average molecular weight is less than 7,000 and more preferably, greater than 500.

The pigment particles used in the dispersion of the invention must have a median particle diameter of less than 200 nm. As used herein, median particle size refers to the 50^{th} percentile such that 50% of the volume of the particles is smaller than the indicated size. This small size is necessary so that ink compositions prepared therefrom may be jetted from ink jet printheads having small nozzle sizes, for example, less than 20 microns. In a preferred embodiment, the median particle size is 100 nm or less because ink compositions prepared therefrom may be fired reliably over extended periods of time. Reliable jetting occurs when individual streams of ink droplets can be jetted continuously from each of the printhead nozzles without any nozzles shutting down, either temporarily or permanently. In another preferred embodiment, the median particle size is 50 nm or less because ink compositions prepared therefrom enable reliable jetting for high performance ink jet printing systems.

The pigment dispersion of the invention may be yellow, magenta, cyan, black, gray, red, violet, blue, green, orange, brown, etc., and a wide variety of organic and inorganic pigments, alone or in combination, are well known in the art for producing the desired color. The exact choice of pigments will depend upon the specific application and performance requirements such as color reproduction and image stability.

Pigments suitable for use in the invention include azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black.

Typical examples of pigments that may be used include Color Index (C.I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147,148, 150, 151, 152,153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C.I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C.I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50; or C.I. Pigment Brown 1, 5, 22, 23, 25, 38, 41, 42.

In a preferred embodiment of the invention, the pigment is C.I. Pigment Blue 15:3, C.I. Pigment Red 122, C.I. Pigment Red 177, C.I. Pigment Red 202, C.I. Pigment Yellow 155, C.I. Pigment Yellow 74, C.I. Pigment Yellow 158, C.I. Pigment Violet 19, C.I. Pigment Violet 23, C.I. Pigment Black 7, or the bis(phthalocyanylalumino)tetraphenyldisiloxane cyan pigment represented by the following formula:
PcAl—O—[SiR₂—O]₂—AlPc
where R is a phenyl group and Pc is unsubstituted. The aforementioned pigments are preferred because they provide better color gamut as compared to those that are not preferred. Particularly useful pigments are disclosed in U.S. Pat. Nos. 5,026,427; 5,086,698; 5,141,556; 5,160,370; and 5,169,436. This invention is particularly useful with C.I. Pigment Yellow 74.

The pigment dispersion of the invention may be prepared by any method known in the art of ink jet printing, provided that a median particle size of 200 nm or less is obtainable with the random addition copolymer dispersants of the invention. In general, the pigment dispersion of the invention is prepared by suspending crude pigment cake and the dispersant in an optional liquid medium along with inert milling media such as polymeric beads, glasses, ceramics, metals and plastics as described, for example, in U.S. Pat. No. 5,891,231. The mixture of crude pigment cake is then milled using any type of grinding mill such as a media mill, a ball mill, a two-roll mill, a three-roll mill, a bead mill, and air-jet mill, an attritor, or a liquid interaction chamber. During the milling step, the crude pigment cake is broken up into primary pigment particles, commonly referred to in the art as pigment particles. When the desired particle size is obtained, the inert milling media are removed by filtration, and the resulting filtrate is the pigment dispersion. The weight ratio of polymeric dispersant to pigment particles in the milling step is preferably 0.1:1 to 5:1.

The pigment dispersion of the invention can be used to prepare an ink jet ink composition, often referred to in the art as a pigment-based ink composition. The amount of pigment dispersion used in the ink composition of the invention varies such that the pigment particles are present in an amount of 0.5 to 30 weight percent of the total ink composition. Typically, the amount of pigment particles is 0.5 to 10 weight percent of the total ink composition.

The ink composition of the invention is aqueous-based and contains water and a water-miscible organic compound, often referred to in the art as a humectant and/or co-solvent. This organic compound is used to prevent the ink composition from drying out or crusting in the nozzles of the printhead, aid solubility of the components in the ink composition, or facilitate penetration of the ink composition into the image-recording element after printing. Representative examples of humectants and co-solvents used in aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, diethylene glycol, triethylene glycol, tetraethylene glycol, propylene glycol, polyethylene glycol, glycerol, 2-methyl-2,4-pentanediol, 1,2,6-hexanetriol, 2-ethyl-2-hydroxymethyl-1,3-propanediol, 1,5 pentanediol, 1,2-hexanediol, and thioglycol; (3) lower mono- and di-alkyl ethers derived from the polyhydric alcohols; (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol. In a preferred embodiment, the ink composition contains an alcohol, a glycol, glycerol, a glycol ether, an amine or mixtures thereof. Typical aqueous-based ink compositions useful in the invention may contain, for example, the following components based on the total weight of the ink: water up to 90%, humectant(s) 5-70%, and co-solvent(s) 2-20%.

Other components present in the ink composition of the invention include surfactants, defoamers, biocides, buffering agents, conductivity enhancing agents, anti-kogation agents, drying agents, waterfast agents, water soluble and water dispersible polymers, chelating agents, light stabilizers, or ozone stabilizers.

The exact choice of ink components will depend upon the specific application and performance requirements of the printhead from which they are jetted. Thermal and piezoelectric drop-on-demand printheads and continuous printheads each require ink compositions with a different set of physical properties in order to achieve reliable and accurate jetting of the ink, as is well known in the art of inkjet printing. For typical drop-on-demand printheads, viscosities are no greater than 10 cP, and preferably in the range of about 1.0 to 6.0 cP. Continuous type printheads are capable of jetting ink compositions with much higher viscosities, even up to 30 cP. Acceptable surface tensions are no greater than 60 dynes/cm, and preferably in the range of 28 dynes/cm to 45 dynes/cm.

The ink jet ink composition of the invention may be used in an ink jet printing method having the steps of A) providing an ink jet printer that is responsive to digital data signals; B) loading the printer with an ink jet recording element; C) loading the printer with an ink jet ink composition of the invention; and D) printing on the ink jet recording element using the ink jet ink composition in response to the digital data signals. The ink jet recording element used in the method of the invention may be any type used in the art, including but not limited to plain paper, vinyl, canvas, and specialty paper designed specifically for use with ink jet printing.

The following examples are provided to illustrate, but not to limit, the invention.

### EXAMPLES

Preparation of Polymeric Dispersants of the Invention

Polymeric Dispersant 1 (PD-1)

100 g of diethylene glycol (DEG) and 0.25 g of 2,2′-azobisisobutyronitrile (AIBN) were charged to a 1-liter, three-neck round-bottom flask equipped with a mechanical stirrer and nitrogen inlet. The resulting solution was purged with nitrogen for 20 minutes and heated to 150 degrees Centigrade in a constant temperature bath. In a separate container, 100 g of DEG, 0.25 g of AIBN, 33.5 g of benzyl methacrylate (BMA), and 16.5 g of methacrylic acid (MAA) were combined, mixed well, and then added to the first solution over 2 hours. Polymerization was continued for 3 hours. The temperature was reduced to 65-70 degrees Centigrade, and 1 mL each of t-butyl hydroperoxide (10 weight percent) and sodium formaldehyde bisulfite (10 weight percent) were then added. The resulting polymer was isolated and a 20 wt. % aqueous solution prepared by neutralizing the polymer to 65-70 wt. % with potassium hydroxide.

Number average molecular weight of the resulting polymer was determined by size-exclusion chromatography using a PLGel™ Mixed-B column (Polymer Laboratories) in tetrahydrofuran solvent and calibrated with polystyrene standards having narrow a molecular weight distribution between 580 and 2,300,000. Random copolymer of BMA/MAA in a 67/33 weight ratio was found to have a number average molecular weight of 4960.

Polymeric Dispersant 2 (PD-2)

PD-2 was prepared and analyzed the same as PD-1 except that 30.0 g of BMA and 20.0 g of MAA were used. Random copolymer of BMA/MAA in a 60/40 weight ratio was found to have a number average molecular weight of 5020. The resulting polymer was dissolved in water to pH 7 using potassium hydroxide to give a 20 wt. % solution of PD-2.

Polymeric Dispersant 3 (PD-3)

16.5 g of MAA, 33.5 g of BMA, 0.5 g of 1-dodecanethiol, 100 mL of methylethyl ketone, and 0.25 g of AIBN were mixed under nitrogen atmosphere in a 1-liter, three-neck round-bottom flask equipped with a reflux condenser. The solution was stirred and purged with nitrogen for 20 minutes and heated to 70 degrees Centigrade in a constant temperature bath. After 24 hours, the resulting solution was cooled and added slowly to hexane with rapid stirring. A white precipitate appeared and was collected by filtration under suction and dried in vacuo to give a white powder. The powder was analyzed the same as PD-1. Random copolymer of BMA/MAA in a 67/33 weight ratio was found to have a number average molecular weight of 4870. The resulting polymer was dissolved in water to pH 7 using potassium hydroxide to give a 20 wt. % solution of PD-3

Control Polymeric Dispersant 1 (CCPD-1) (Styrene/MAA 60/40)

30.0 g of styrene, 20.0 g of MAA, 0.5 g of 1-dodecanethiol, 100 mL of methylethyl ketone, and 0.25 g of AIBN were mixed under nitrogen atmosphere in a 1-liter, three-neck round-bottom flask equipped with a reflux condenser. The solution was stirred and purged with nitrogen for 20 minutes and heated to 70 degrees Centigrade in a constant temperature bath. After 24 hours, the resulting solution was cooled and added slowly to hexane with rapid stirring. A white precipitate appeared and was collected by filtration under suction and dried in vacuo to give a white powder. The resulting polymer was dissolved in water to pH 7 using potassium hydroxide to give a 20 wt. % solution of CCPD-1.

Control Polymeric Dispersant 2 (CCPD-2) (MMA/Vinyl Acetate/MAA 45/20/35)

CCPD-2 was prepared the same way as CCPD-1 except the monomers were 22.5 g of MMA, 10.0 g of vinyl acetate and 17.5 g of MAA. The final polymer was dissolved in water to pH 7 using potassium hydroxide to give a 20 wt. % solution of CCPD-2.

Preparation of Pigment Dispersions

Magenta Pipment Dispersion 1 of the Invention (MPD-1)

A mixture of 250 g of polymeric beads having mean diameter of 50 μm, 25.0 g of Pigment Red 122 (Sun Chemical Corp.); 62.5 g of a 20 wt. % solution of PD-1 (12.5 g of PD-1) was prepared and diluted with water to give a total of 525 g. The mixture was milled for one hour at 1000 RPM using a Premier Mill 2500HV laboratory dispersator equipped with a 3.8 cm (1.5 in.) Cowles blade, and then for an additional 23 hours at 2500 RPM while holding the temperature of the mixture constant at 23 degrees Centigrade. The mixture was then allowed to set for 12 hours. Milling media were removed by filtering the mixture through a 10 micron screen under vacuum into a glass flask. The filtrate was then filtered through a one micron binder-free glass fiber filter (Pall Corp.) to obtain MPD-1 having approximately 10 wt. % pigment. The ratio of polymer/pigment was approximately 1:2.

The median particle size of MPD-1 was measured using a Microtrac® Ultrafine Particle Analyzer 150 from Microtrac, Inc. As used herein, median particle size refers to the 50^{th} percentile such that 50% of the volume of the particles is smaller than the indicated size. The median particle size for MPD-1 was 24 nm.

Yellow Pigment Dispersion 1 of the Invention (YPD-1)

YPD-1 was prepared the same as the MPD-1 except that Pigment Yellow 155 (Clariant Corp.) was used instead of Pigment Red 122. The median particle size for YPD-1 was 14 nm.

Yellow Pigment Dispersion 2 of the Invention (YPD-2)

YPD-2 was prepared the same as MPD-1 except that Pigment Yellow 97 (Clariant Corp.) was used instead of Pigment Red 122. The median particle size for YPD-2 was 54 nm.

Cyan Pigment Dispersion 1 of the Invention (CPD-1)

CPD-1 was prepared the same as the MPD-I except that Pigment Blue 15:3 (Sun Chemical Corp.) was used instead of Pigment Red 122. The median particle size for CPD-1 was 50 nm.

Control Magenta Pigment Dispersion (Control MPD)

Control MPD was prepared the same as MPD-1 except that 6.25 g of potassium oleoylmethyltaurate (KOMT) was used instead of PD-1. The median particle size for Control MPD was 14 nm. The ratio of KOMT: polymer was approximately 4:1.

Control Yellow Pigment Dispersion (Control YPD)

Control YPD was prepared the same as YPD-1 except that 6.25 g of KOMT was used instead of PD-1. The median particle size for Control YPD was 18 nm. The ratio of KOMT: polymer was approximately 4:1.

Control Cyan Pigment Dispersion (Control CPD)

Control CPD was prepared the same as CPD-1 except that 6.25 g of KOMT was used instead of PD-1. The median particle size for Control CPD was 25 nm. The ratio of KOMT: polymer was approximately 4:1.

Pigment Dispersions Using Control Polymeric Dispersions CCPD-1 and CCPD-2

Pigment dispersions could not be made using these polymers. CCPD-1, when milled as described above, became highly viscous, and eventually solidified during overnight milling. CCPD-2 also became highly viscous upon milling and completely gelled over time.

Evaluation of Pigment Dispersions

Each of the pigment dispersions described above were evaluated for particle stability by incubating samples at 60 degrees Centigrade for one, two and four week periods and then remeasuring the median particle size. The resulting data are summarized in Table 1.

TABLE 1

| | Median Particle Size (nm) | | | |
|---|---|---|---|---|
| Pigment | | After 1 | After 2 | After 4 |
| Dispersion | Initial | Week | Weeks | Weeks |
| MPD-1 | 24 | 16 | 17 | 17 |
| Control MPD | 14 | NM | NM | NM |
| YPD-1 | 14 | 15 | 16 | 19 |
| YPD-2 | 54 | 67 | 53 | 67 |
| Control YPD | 18 | NM | NM | NM |
| CPD-1 | 50 | 51 | 62 | 62 |
| Control CPD | 25 | NM | NM | NM |

NM = not measured

The data in Table 1 show that the pigment dispersions of the invention have median particle sizes comparable to the comparative pigment dispersions. Table 1 also shows that the pigment dispersions of the invention exhibit excellent particle stability, even after four weeks at 60 degrees Centigrade.

Preparation of Ink Compositions

Ink compositions were prepared using the pigment dispersions described above as shown in Table 2. The ink compositions consisted of pigment dispersion at pigment 2.5 wt. %, diethylene glycol at 12 wt. %, and Surfynol® 465 (Air Products and Chemicals, Inc.) at 0.3 wt. %.

Printing

The ink compositions described above were printed using the Canon s520 ink jet printer. Ink cartridges for use with this printer were emptied and filled with the ink compositions described above, then the ink cartridges were loaded into one of the C, M, Y or K ports. A test image consisting of four density patches at 100, 75, 50 and 25% ink laydowns was printed for each ink composition on Konica QP Photo Quality Ink Jet Paper.

Evaluation of Ink Compositions

Particle Stability

Evaluation of particle stability for each of the ink compositions was carried out the same as for the pigment dispersions. Stabilities were comparable to those of the corresponding pigment dispersions in that little or no change in particle size was found.

Lightfastness

Each of the printed test images were subjected to 4 weeks of light fade under 50 kLux high-intensity sunlight produced by filtration of a Xenon light source. For each patch in a given test image, the appropriate red, green or blue Status A densities were measured both before and after treatment, and the average percent density loss for the four patches determined. Results are tabulated in Table 2.

Ozonefastness

Each of the printed test images were subjected to one week of ozone fade in a chamber regulated with 5 parts per million ozone concentration, 50% relative humidity, and at 21 degrees Centigrade. Average percent density losses were determined as described above. Results are tabulated in Table 2.

Rub Resistance

Testing was carried out by rubbing the density patch having 100% dot coverage with a dry paper towel for 8 passes under a pressure of 200 g over 3.5 cm², and visually evaluating extent of smearing. Results are tabulated in Table 2.

TABLE 2

| | | Lighfastness | Ozonefastness | |
|---|---|---|---|---|
| | Pigment | Average % | Average % | Rub |
| Ink | Dispersion | Fade | Fade | Resistance |
| Ink M-1 | MPD-1 | 11 | 28 | no smear |
| Control Ink | Control | 11 | 28 | slight smear |
| M-1 | MPD | | | |
| Ink Y-1 | YPD-1 | 44 | 24 | no smear |
| Control Ink | Control YPD | 32 | 25 | slight smear |
| Y-1 | | | | |
| Ink C-1 | CPD-1 | 11 | 25 | no smear |
| Control Ink | Control CPD | 76 | 24 | slight smear |
| C-1 | | | | |

The results in Table 2 show that the ink compositions of the invention exhibit excellent lightfastness and ozonefastness comparable to the control ink compositions. Lightfastness of the cyan pigment used in Ink C-1 and Control Ink C-1 increased considerably when formulated according to the invention. In addition, rub resistance for the inventive inks was excellent in that no smear was observed compared to the comparative inks that exhibited slight smear.

The invention has been described in detail with particular reference to certain preferred embodiments thereof, but it will be understood that variations and modifications can be effected within the spirit and scope of the invention.

1. A pigment dispersion for an ink jet ink composition, the pigment dispersion comprising pigment particles having a median particle size of 200 nm or less, and a polymeric dispersant comprising a random addition copolymer comprising at least one hydrophobic monomer type and at least one hydrophilic monomer type, wherein the polymeric dispersant comprises from 50 weight percent to 80 weight percent of hydrophobic monomers relative to the total weight of the polymeric dispersant, and wherein, when the polymer comprises more than one hydrophobic monomer type, at least 50 weight percent of the hydrophobic monomers relative to the total weight of the hydrophobic monomers is an acrylate comprising an aromatic group.

2. The pigment dispersion of claim 1 wherein the pigment particles have a median particle size of 100 nm or less.

3. The pigment dispersion of claim 1 wherein the acrylate is a methacrylate.

4. The pigment dispersion of claim 1 wherein the aromatic group is phenyl group.

5. The pigment dispersion of claim 1 wherein the acrylate is benzyl methacrylate.

6. The pigment dispersion of claim 1 wherein the acrylate has a molecular weight of less than 200.

7. The pigment dispersion of claim 1 wherein the hydrophilic monomer type(s) comprise a carboxylic acid group.

8. The pigment dispersion of claim 1 wherein the hydrophilic monomer type(s) are acrylic acid, methacrylic acid, or derivatives thereof.

9. The pigment dispersion of claim 1 wherein up to 50 weight percent of the hydrophobic monomers relative to the total weight of the hydrophobic monomes is an acrylate not comprising an aromatic group.

10. The pigment dispersion of claim 9 wherein the acrylate not comprising an aromatic group has a molecular weight of less than 200.

11. The pigment dispersion of claim 1, wherein the hydrophobic monomer type is benzyl methacrylate, and the hydrophilic monomer type is methacrylic acid.

12. The pigment dispersion of claim 1 wherein the polymeric dispersant has a number average molecular weight of less than 50,000.

13. The pigment dispersion of claim 1 wherein the polymeric dispersant has a number average molecular weight of less than 15,000.

14. The pigment dispersion of claim 1 wherein the polymeric dispersant has a number average molecular weight of less than 7,000.

15. The pigment dispersion of claim 1 wherein the polymeric dispersant has a number average molecular weight of greater than 500.

16. The pigment dispersion of claim 1 having a weight ratio of polymeric dispersant to pigment particles is from 0.1:1 to 5:1.

17. The pigment dispersion of claim 1 wherein the pigment particles are C.I. Pigment Blue 15:3, C.I. Pigment Red 122, C.I. Pigment Red 177, C.I. Pigment Red 202, C.I. Pigment Yellow 155, C.I. Pigment Yellow 74, C.I. Pigment Yellow 158, C.I. Pigment Violet 19, C.I. Pigment Violet 23, C.I. Pigment Black 7, or the bis(phthalocyanylalumino)tetraphenyldisiloxane cyan pigment represented by the following formula:
PcAl—O—[SiR₂—O]₂—AlPc
where R is a phenyl group and Pc is unsubstituted.

18. The pigment dispersion of claim 1 wherein the pigment particles are C.I. Pigment Yellow 74.

19. The pigment dispersion of claim 1 wherein 100% of the hydrophobic monomer is an acrylate comprising an aromatic group.

20. An ink composition comprising a pigment dispersion, water and a water-miscible organic compound; the pigment dispersion comprising pigment particles having a median particle size of 200 nm or less, and a polymeric dispersant comprising a random addition copolymer comprising at least one hydrophobic monomer type and at least one hydrophilic monomer type, wherein the polymeric dispersant comprises from 50 weight percent to 80 weight percent of hydrophobic monomers relative to the total weight of the polymeric dispersant, and wherein, when the polymer comprises more than one hydrophobic monomer type, at least 50 weight percent of the hydrophobic monomers relative to the total weight of the hydrophobic monomers is an acrylate comprising an aromatic group.

21. The ink composition of claim 20 wherein the pigment particles have a median particle size of 100 nm or less.

22. The ink composition of claim 20 wherein the pigment particles comprise 0.5 to 30 weight percent of the total ink composition.

23. The ink composition of claim 20 wherein water is present in an amount of up to 90 weight percent of the total ink composition.

24. The ink composition of claim 20 wherein the water-miscible organic compound is an alcohol, a glycol, glycerol, a glycol ether, an amine or mixtures thereof.

25. The ink composition of claim 20 wherein the hydrophobic monomer type is benzyl methacrylate, and the hydrophilic monomer type is methacrylic acid.

26. The ink composition of claim 19 wherein the pigment particles are C.I. Pigment Yellow 74.

27. An ink jet printing method comprising the steps of:
A) providing an ink jet printer that is responsive to digital data signals;
B) loading the printer with an ink jet recording element;
C) loading the printer with an ink jet ink composition comprising a pigment dispersion, water and a water-miscible organic compound; the pigment dispersion comprising pigment particles having a median particle size of 200 nm or less, and a polymeric dispersant comprising a random addition copolymer comprising at least one hydrophobic monomer type and at least one hydrophilic monomer type, wherein the polymeric dispersant comprises from 50 weight percent to 80 weight percent of the hydrophobic monomes relative to the total weight of the polymeric dispersant, and wherein, when the polymeric dispersant comprises more than one hydrophobic monomer type, at least 50 weight percent of the hydrophobic monomers relative to the total weight of the hydrophobic monomers is an acrylate comprising an aromatic group; and
D) printing on the ink jet recording element using the ink jet ink composition in response to the digital data signals.

28. The pigment dispersion of claim 1 wherein the hydrophilic monomer type(s) comprise an amine group.
